(19) United States
(12) Patent Application Publication
(10) Pub. No.: US 2004/0096549 A1
(43) Pub. Date: May 20, 2004

(54) Method of pre-soaking and reinforcing non-edible collagen casings

(75) Inventor: Goran Rydenfors, Klagerup (SE)

Correspondence Address: BURNS DOANE SWECKER & MATHIS L L P, POST OFFICE BOX 1404, ALEXANDRIA, VA, 22313-1404, US

(73) Assignee: AB TRIPASIN, Malmo (SE)

(21) Appl. No.: 10/699,738

(22) Filed: Nov. 4, 2003

(30) Foreign Application Priority Data
Nov. 15, 2002 (SE) 0203371-0

(51) Int. Cl. A23L 1/315; A23L 1/31

(52) U.S. Cl. 426/105; 452/32

(57) ABSTRACT

The present invention concerns an improved method of pre-soaking a non-edible collagen casing for foodstuffs and reinforcing the clip strength and cooking resistance thereof, the method comprising treating the dried collagen casing with an aqueous solution of at least one salt selected from the group consisting of sodium bicarbonate, sodium sulphate, ammonium chloride, calcium chloride, sodium hydrogen phosphate, potassium hydrogen phosphate, potassium chloride, ammonium sulphate, optionally in combination with sodium chloride, the total salt concentration being in the range of 5-18% by weight.

### FIELD OF THE INVENTION

The present invention relates to a method of presoaking a non-edible collagen casing for foodstuffs and reinforcing the clip strength and cooking resistance thereof.

### BACKGROUND ART

In the foodstuffs industry, there are different kinds of collagen casings which are suitable for being stuffed with various foodstuffs, in particular meat mixtures. The properties of the collagen casing are important for the type of foodstuffs used as stuffing, since the stuffing may vary significantly in terms of, for example, both consistency and temperature. For collagen casings that are used for hard foodstuff stuffings, such as salami—where the stuffing is frozen, the collagen casing must have excellent properties in terms of strength and resistance. Today, not all collagen casings are sufficiently stable and durable for the stuffings available.

SE 515,441 discloses a non-edible collagen casing intended for foodstuffs and a method of softening, stabilizing and preserving it. According to said method, the dried collagen casing is treated with an aqueous solution of sodium chloride in a concentration of 5-25% by weight. The purpose of pre-soaking the casing is that it can be done in an effective manner without raising the price of the product to any appreciable extent. The sausage maker saves valuable production time, since he or she does not have to pre-soak the casing before stuffing.

The aim of the experiments carried out in connection with the present invention has been to provide a stronger collagen casing in terms of cooking resistance and clip strength, while reducing the amount of NaCl for environmental reasons.

### SUMMARY OF THE INVENTION

In one aspect, the present invention relates to a method of pre-soaking a non-edible collagen casing for foodstuffs and reinforcing the clip strength and cooking resistance thereof, the method comprising treating the dried collagen casing with an aqueous solution of at least one salt selected from the group consisting of sodium bicarbonate, sodium sulphate, ammonium chloride, calcium chloride, sodium hydrogen phosphate, potassium hydrogen phosphate, potassium chloride, ammonium sulphate, optionally in combination with sodium chloride, the total salt concentration being in the range of 5-18% by weight.

According to a further aspect, the invention concerns a pre-soaked, reinforced non-edible collagen casing, which is obtainable by means of said method.

### DESCRIPTION OF PREFERRED EMBODIMENTS

In a preferred embodiment of the method according to the invention, the salt concentration is in the range of 8-12% by weight.

In a further embodiment of the method, the aqueous solution contains at least two salts. Examples of salt solutions that contain two salts or more are a salt solution containing sodium sulphate (6% by weight) and sodium chloride (2% by weight), a salt solution containing sodium bicarbonate (3% by weight), sodium sulphate (3% by weight) and sodium chloride (4% by weight), a salt solution containing ammonium chloride (5% by weight), sodium chloride (3% by weight) and potassium chloride (2% by weight), a salt solution containing sodium hydrogen phosphate (3% by weight), potassium chloride (3% by weight) and sodium chloride (3% by weight) and a salt solution containing sodium bicarbonate (4% by weight), sodium chloride (4% by weight) and sodium sulphate (2% by weight). Salt solutions containing only one salt can be a salt solution containing only one of the above salts.

In yet another embodiment of the method according to the invention, the pre-soaked non-edible collagen casing is further packed in a packing of a material having good barrier properties, preferably under vacuum.

Accordingly, in conjunction with the present invention the clip strength has been improved. When the collagen casing has been stuffed with a sufficient amount of foodstuffs, the sausages are closed at both ends by means of a metal clip. In the present invention, further improvements have been made in this respect by combining different salts in a solution for preserving the collagen casing.

The different combinations of salts in a solution have an improving effect upon the casing and its properties. Since it is desirable, for environmental reasons, to reduce the discharge of sodium chloride in some countries, the amount of sodium chloride in the salt combinations according to the present invention has been reduced. As a result thereof, an improved collagen casing is obtained, while retaining properties such as storage life, strength and stuffing properties.

The following salts have been tested one at a time and in combination: sodium bicarbonate, ammonium chloride, potassium chloride, sodium sulphate, ammonium sulphate, potassium chloride, sodium hydrogen phosphate and potassium hydrogen phosphate. Besides reducing the amount of sodium chloride, in connection with which the collagen casing retains its stuffing properties and preservation, certain combinations result in improved clip strength and others in improved cooking resistance, while yet other combinations result in both. The cooking resistance is the resistance of the casing during heat treatment of the collagen casing containing the foodstuff, for example sausage. By using sodium sulphate, for example, it has been possible to reduce the salt amount to 8% and replace the sodium chloride completely, which has also resulted in improved clip properties. A better deswelling is obtained when using sodium sulphate, which means that a better clip strength is obtained and/or that the salt amount can be reduced, compared with sodium chloride. Examples relating to different purposes other than the purpose of obtaining a ready-to-stuff casing will be described below.

The phrase “reinforcing a collagen casing” as used in the present description means reinforcing the clip strength and/or cooking resistance of the collagen casing.

### EXAMPLES

### Example 1

### Increased Cooking Resistance and Clip Strength

(3%) sodium bicarbonate, 1-6%

(3%) sodium sulphate, 0-8%

(4%) sodium chloride, 0-4%

### Example 2

### Increased Clip Strength

(6%) sodium sulphate, 2-18%

(2%) sodium chloride, 0-4%

### Example 3

### Increased Cooking Resistance

(5%) ammonium chloride, 2-10%

(4%) sodium chloride, 0-4%

(2%) calcium chloride, 0-10%

### Example 4

### Increased Cooking Resistance

(3%) sodium hydrogen phosphate, 0-6%

(3%) potassium chloride, 0-10%

(3%) sodium chloride, 0-4%

### Example 5

### Increased Cooking Resistance

(4%) sodium bicarbonate, 2-6%

(4%) sodium chloride, 2-4%

(2%) sodium sulphate, 0-4%

### Example 6

### Increased Clip Strength

(8%) sodium sulphate, 4-18%

### Example 7

### Increased Clip Strength

(10%) ammonium sulphate, 4-18%

In the above examples, the used concentration of the salt is indicated in brackets in percentage by weight in front of each salt. The range indicated after the salt refers to the concentration range within which the salt in question can be used in combination with the other salts of the example when carrying out the method according to the invention. In the present invention, the term “%” or “per cent” is intended to cover percentages by weight.

The above examples are merely illustrative and are not to be considered as limitative of the present invention. Other combinations of the indicated salts are conceivable and other salts that are not mentioned herein can be used, provided that they achieve the advantages of the present invention. Nor is the invention limited to the specific salt concentrations used above.

Tests and analyses have been carried out on sausage casings which have been produced from the same collagen stock, and extruded, cured, and dried in the same manner. The sausage casings are divided into eight parts, one group of which is a control group (immersed in a 12% solution of sodium chloride). The other samples are subjected to the salt solution concentrations indicated in the above examples 1-7.

The sausage casing samples were allowed to soak up 1.5 times their dry weight. The samples are packed under low vacuum in gas-tight plastic bags and welded up. The casings were tested again after respectively 1, 3, 6, and 9 months of storage at a temperature of 25° C. Testing at these intervals was carried out to determine stuffing properties, clip strength, cooking resistance and bacteriological status.

The clip strength was determined by stuffing the sausages with foodstuffs so that their hardness increased and then measuring the stuffing caliber to determine said hardness. With a normal stuffing pressure, a caliber of 52 mm is obtained. The stuffing pressure was then increased in steps of 0.5 mm until breakage occurred. Five measurements were made on each sample. The average caliber was calculated.

The cooking resistance was determined by hanging the 0.5-m-long sausage casings in a humidification chamber at a temperature of 78° C. for 60 min. The casings were inflated by means of compressed air until they ruptured and the pressure was registered. The average for five sausage casings from each example was calculated.

The bacteriological status was determined by means of agar plates for moulds/yeasts and total bacteria. The plates were pressed against the casing and then grown at 30° C. and 37° C., respectively, for 48 hours. The plates were inspected by ocular examination and divided into no growth, sparse, moderate, abundant and substantial growth. Moderate growth is acceptable.

The results are illustrated in the following tables.

After 1 Month

| | Clip | Cooking | | | |
|---|---|---|---|---|---|
| | strength | resistance | Stuffing | Bacterial | Moulds/ |
| Ex. | (mm) | (hp/cm²) | properties | growth | yeasts |
| Ref. | 53.8 | 3.1 | good | None | sparse |
| 1 | 55.4 | 7.2 | slightly hard in | None | sparse |
| | | | stuffing break | | |
| 2 | 56.7 | 2.9 | rigid and slightly | None | none |
| | | | hard | | |
| 3 | 54.1 | 3.7 | flexible | Sparse | none |
| 4 | 54.7 | 6.8 | good | Sparse | sparse |
| 5 | 54.2 | 6.5 | good, flexible | Sparse | sparse |
| 6 | 57.1 | 3.2 | slightly hard and | Sparse | none |
| | | | rigid | | |
| 7 | 56.1 | 3.3 | flexible | Sparse | none |

After 3 Months

| | Clip | Cooking | | | |
|---|---|---|---|---|---|
| | strength | resistance | Stuffing | Bacterial | Moulds/ |
| Ex. | (mm) | (hp/cm²) | properties | growth | yeasts |
| Ref. | 54.1 | 2.9 | good | None | sparse |
| 1 | 55.8 | 6.8 | slightly hard in | None | sparse |
| | | | stuffing break | | |
| 2 | 56.9 | 2.8 | rigid and slightly | None | sparse |
| | | | hard | | |
| 3 | 53.7 | 3.6 | flexible | Moderate | none |
| 4 | 54.3 | 6.7 | good | Sparse | sparse |
| 5 | 54.1 | 7.0 | good, flexible | Sparse | sparse |
| 6 | 57.1 | 3.1 | slightly rigid and | Sparse | none |
| | | | hard | | |
| 7 | 56.5 | 2.9 | slightly hard but | Sparse | none |
| | | | flexible | | |

After 6 Months

| | Clip | Cooking | | | |
|---|---|---|---|---|---|
| | strength | resistance | Stuffing | Bacterial | Moulds/ |
| Ex. | (mm) | (hp/cm²) | properties | growth | yeasts |
| Ref. | 54.3 | 3.2 | good | Sparse | moderate |
| 1 | 56.0 | 6.9 | slightly hard in | Sparse | sparse |
| | | | stuffing break | | |
| 2 | 57.1 | 3.0 | rigid and slightly | Sparse | sparse |
| | | | hard | | |
| 3 | 53.6 | 3.2 | flexible | Moderate | sparse |
| 4 | 54.6 | 7.3 | good | Sparse | moderate |
| 5 | 53.9 | 6.8 | good, flexible | Sparse | moderate |
| 6 | 56.9 | 2.8 | rigid and hard | Sparse | sparse |
| 7 | 56.4 | 3.0 | hard but flexible | Sparse | sparse |

After 9 Months

| | Clip | Cooking | | | |
|---|---|---|---|---|---|
| | strength | resistance | Stuffing | Bacterial | Moulds/ |
| Ex. | (mm) | (hp/cm²) | properties | growth | yeasts |
| Ref. | 53.7 | 2.8 | good | Moderate | moderate |
| 1 | 55.7 | 6.7 | slightly hard in | Sparse | moderate |
| | | | stuffing break | | |
| 2 | 56.4 | 2.7 | rigid and slightly | Sparse | moderate |
| | | | hard | | |
| 3 | 53.8 | 3.5 | flexible | Moderate | moderate |
| 4 | 53.9 | 6.9 | good | Sparse | moderate |
| 5 | 54.2 | 6.7 | good, flexible | Sparse | moderate |
| 6 | 57.2 | 2.9 | hard and rigid | Moderate | sparse |
| 7 | 56.7 | 3.2 | slightly hard and | Moderate | sparse |
| | | | semi-flexible | | |

As shown in the tables, a better clip strength is obtained with examples 1, 2, 6 and 7, and, in addition, a high cooking resistance with example 1. A better cooking resistance is obtained also with examples 1, 3, 4 and 5. The stuffing properties vary, but in general the casing gets slightly more rigid and inflexible with increased clip strength. All samples had good storage stability. Owing to the improved properties of the collagen casing in the form of improved cooking resistance obtained in conjunction with the present invention, such improved collagen casings can be used, for example, in processes which require higher temperatures. As a result, the finished sausage products can be obtained more rapidly.

What I claim and desire to secure by Letters Patent is:

1. A method of pre-soaking a non-edible collagen casing for foodstuffs and reinforcing the clip strength and cooking resistance thereof, characterized by treating the dried collagen casing with an aqueous solution of at least one salt selected from the group consisting of sodium bicarbonate, sodium sulphate, ammonium chloride, calcium chloride, sodium hydrogen phosphate, potassium hydrogen phosphate, potassium chloride, ammonium sulphate, optionally in combination with sodium chloride, the total salt concentration being in the range of 5-18% by weight.

2. A method according to claim 1, wherein the total salt concentration is in the range of 8-12% by weight.

3. A method according to claim 1 or 2, wherein the aqueous solution contains at least two salts.

4. A method according to any one of claims 1-3, wherein the pre-soaked non-edible collagen casing is further packed in a packing of a material having good barrier properties.

5. A pre-soaked, reinforced non-edible collagen casing, which is obtainable by means of the method according to any one of claims 1-4.
